(19) United States
(12) Patent Application Publication
(10) Pub. No.: US 2026/0140281 A1
(43) Pub. Date: May 21, 2026

(54) Machine Learning Systems and Methods for Continuous Latent Representations for Modeling Precipitation Using Deep Learning

(71) Applicant: Insurance Services Office, Inc., Jersey City, NJ (US)

(72) Inventors: Gokul Radhakrishnan, Hyderabad (IN); Rahul Sundar, Hyderabad (IN); Nishant Parashar, Saharanpur (IN); Antoine Blanchard, Boston, MA (US); Daiwei Wang, Sharon, MA (US); Boyko Dodov, Mansfield, MA (US)

(73) Assignee: Insurance Services Office, Inc., Jersey City, NJ (US)

(21) Appl. No.: 19/394,398

(22) Filed: Nov. 19, 2025

Related U.S. Application Data
(60) Provisional application No. 63/722,367, filed on Nov. 19, 2024.

(51) Int. Cl. G01W 1/14; G06N 3/0455

(52) U.S. Cl. CPC G01W 1/14; G06N 3/0455

(57) ABSTRACT

Machine learning systems and methods for continuous latent representations for modeling precipitation using deep learning are provided. The system includes aa precipitation modeling processor and a precipitation modeling engine executed by the processor. The precipitation modeling engine causing the processor to receive a first dataset including vertically-integrated moisture divergence (VIMD) data, receive a second dataset including total precipitation (TP) data, process the VIMD data and the TP data to blend the VIMD data and the TP data into a pseudo-precipitation (PP) field using a machine learning encoder, and process the PP field using a machine learning decoder to reconstruct the TP data from the PP field.

### RELATED APPLICATIONS

The present application claims the benefit of U.S. Provisional Application Ser. No. 63/722,367 filed on Nov. 19, 2024, the entire disclosure of which is expressly incorporated herein by reference.

### TECHNICAL FIELD

The present disclosure relates generally to the field of computerized weather modeling. More specifically, the present disclosure relates to machine learning systems and methods for continuous latent representations for modeling precipitation using deep learning.

### RELATED ART

Precipitation is a key driver of the Earth's hydrological cycle, making its accurate modelling crucial for studying atmospheric processes. Skillful estimation of precipitation through accurate computer modeling is vital for various human activities, such as transportation and agriculture. Unlike smoother meteorological variables such as temperature, water vapor, and wind speed, precipitation data is sparse and exhibits significant spatial variability. Despite major advancements in numerical weather prediction (NWP) and global circulation models (GCMs), these computerized models still face challenges in accurately predicting extreme precipitation events, like heavy rainfall, due to limitations in resolution and parameterization. These models are further constrained by high computational demands of simulating global climate.

Precipitation data presents several inherent complexities that make its post processing particularly challenging. Precipitation has high spatio-temporal variability, resulting in vast regions with zero values interspersed with sporadic positive values that can increase exponentially in magnitude. The low frequency of extreme precipitation events adds to the complexity. Moreover, both precipitation and the various multi-scale factors contributing to its formation display non-normal and nonlinear behaviors.

These challenges are particularly evident in downstream applications such as statistical post-processing, downscaling, nowcasting, and forecasting. Various research groups have utilized statistical methods to address the complexities of precipitation data, especially in bias correction. The statistical post-processing of simulated precipitation from NWP models lack proper consideration of a number of moisture-related properties of non-precipitating members of the ensemble that likely have discriminating information on the calibration forecasts. This issue is more pronounced when the ensemble forecast is dry-biased, making the statistical adjustment process more complicated. To address this issue, one approach proposed a statistically continuous variable called pseudo-precipitation obtained after blending precipitation and integrated vapor deficit (IVD) together.

Accordingly, what would be desirable, but have not yet been provided, are machine learning systems and methods for continuous latent representations for modeling precipitation using deep learning which address the foregoing and other needs.

### SUMMARY

The present disclosure relates to machine learning systems and methods for continuous latent representations for modeling precipitation using deep learning. The system includes a precipitation modeling processor and a precipitation modeling engine executed by the processor. The precipitation modeling engine causing the processor to receive a first dataset including vertically-integrated moisture divergence (VIMD) data, receive a second dataset including total precipitation (TP) data, process the VIMD data and the TP data to blend the VIMD data and the TP data into a pseudo-precipitation (PP) field using a machine learning encoder, and process the PP field using a machine learning decoder to reconstruct the TP data from the PP field.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing features of the invention will be apparent from the following Detailed Description of the Invention, taken in connection with the accompanying drawings, in which:

FIG. 1 is a diagram illustrating the machine learning systems and methods of the present disclosure;

FIG. 2 is a flowchart illustrating process steps carried out by the machine learning system of FIG. 1;

FIG. 3 illustrates low-and high-resolution pairs of total precipitation data;

FIG. 4 illustrates low-and high-resolution pairs of pseudo-precipitation data;

FIG. 5 illustrates decoding of downscaled pseudo-precipitation data downscaled by the systems and methods of the present disclosure to total precipitation data;

FIG. 6 depicts graphs illustrating power spectral density (PSD) and Q-Q plots; and

FIG. 7 illustrates comparison of the number of days of extreme precipitation per year for the model of the present disclosure versus the ERA5 dataset.

### DETAILED DESCRIPTION

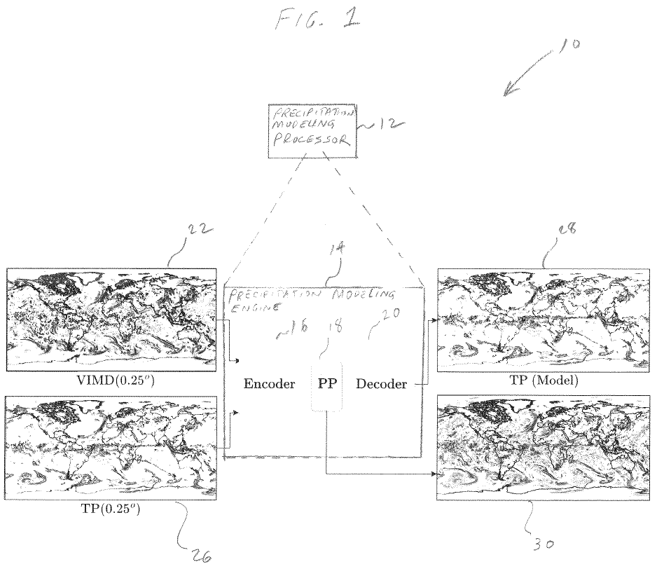

The present disclosure relates to machine learning systems and methods for continuous latent representations for modeling precipitation using deep learning, as discussed in greater detail below in connection with FIGS. 1-7.

As will be discussed in greater detail below, to achieve a consistent representation for precipitation while preserving its key characteristics, the systems and methods of the present disclosure implement machine learning for generating pseudo-precipitation fields. For transforming Total Precipitation (TP) into a spatio-temporally continuous field, the system utilizes Vertically Integrated Moisture Divergence (VIMD), which contains relevant information pertaining to decrease (divergence) or increase (convergence) of moisture within a vertical column of air. Unlike IVD, VIMD can take both negative and positive values and its spatial correlation structure is similar to TP. This allows for more effective blending, specifically at point of discontinuity through deep learning techniques, as detailed below. Further, the system performs the blending of pseudo-precipitation field targeted towards a symmetric Gaussian distribution. The smoother Gaussian blending makes precipitation data more manageable for analysis, enhancing the coherence and accuracy of post-processing models. Additionally, it offers improved physical consistency by representing the processes driving precipitation patterns and facilitate the integration of precipitation with other climate variables.

FIG. 1 is a diagram illustrating the machine learning systems and methods of the present disclosure, indicated generally at 10. The system includes a precipitation modeling processor 12 and a precipitation modeling engine 14 executed by the processor 12. The engine 14 includes an encoder 16 which processes VIMD data 22 and TP data 26 as inputs and generates pseudo-precipitation (PP) field 18 (also illustrated as a Gaussian field 30), and a decoder 20 which processes the PP field 18 to produce TP output data 28. The PP field 18 can be represented as a smooth Gaussian field generated by blending the VIMD data 22 and the TP data 26.

VIMD is used by the system 10 and is defined as the vertical integral of the moisture flux for a column of air extending from the surface of the Earth to the top of the atmosphere. Its horizontal divergence is the rate of moisture spreading outward from a point, per square meter. Positive values indicate moisture divergence (dry conditions) and negative values indicate moisture convergence (potential condensation). VIMD's spatial correlation structure closely resembles that of TP, making it a suitable candidate for blending with TP. To ensure seamless integration of VIMD and TP, the system 10 blends them into a Gaussian distribution as symmetric distributions are preferred for statistical processing. Additionally, VIMD is a native ERA5 variable along with TP improving ease of analysis.

The system 10 implements a fully connected encoder-decoder machine learning framework, specially trained on point-wise global ERA5 Reanalysis data (e.g., over 30 years of ERA5 Reanalysis data, with an additional 10 years used for testing and validation). The encoder 16 blends the TP data 26 and the VIMD data 22 into the Gaussian-distributed PP field 18. A quantile loss is used to align the distribution of PP with that of a standard normal distribution. The decoder 20 then reconstructs TP from the PP field 18, generating the output TP data 28. This neural network framework offers a more flexible and expressive way to parameterize the blended field, while also enabling the decoding of precipitation from the blended field. The engine 14 implements a point-wise machine learning model that is fully connected and trained on global ERA5 Reanalysis data. The loss functions of the model could include a quantile loss expressed as MSE (Q_{Normal}, Q_{PP}) and a reconstruction loss expressed as MSE (TP_{ERA5}, TP_{model}).

It is noted that the precipitation modeling processor 12 could be any suitable computing system capable of executing the precipitation modeling engine 14, including a standalone computer system (e.g., personal computer, laptop computer, desktop computer, tablet computer, smart phone, etc.), a server, or a cloud-based computing platform. The engine 14 could be embodied as non-transitory, computer-readable instructions stored on a computer-readable storage medium (memory) and coded in any suitable high-or low-level computer programming language, including, but not limited to, C, C++, C#, Java, Python, or any other suitable language. The engine 14 may be configured to execute on a variety of hardware architectures, including central processing units (CPUs), graphics processing units (GPUs), and heterogeneous computing environments. In certain embodiments, the engine 14 leverages GPU acceleration to exploit massively parallel processing capabilities, which can significantly improve computational throughput and reduce execution time compared to CPU-only implementations. This compatibility enables the engine 14 to utilize the latest advancements in GPU technology, such as optimized memory bandwidth, tensor cores, and parallel execution units, thereby enhancing performance for large-scale numerical computations.

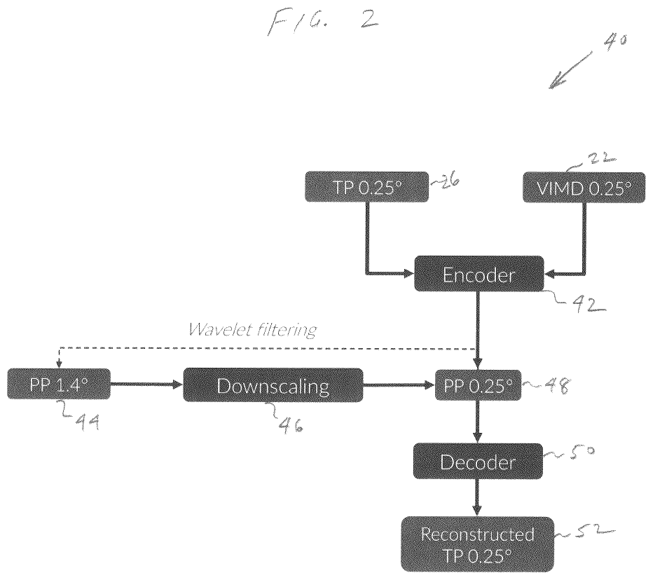

FIG. 2 is a flowchart illustrating process steps carried out by the machine learning system of FIG. 1, indicated generally at 40. In step 42, the encoder 16 blends the TP data 26 and the VIMD data 22 to generate the PP field 18. Additionally, it is noted that the PP field 18 could be generated in step 46 using downscaling and wavelet filtering applied to an input PP field 44. This results in highly accurate downscaling of pseudo-precipitation, and the downscaled field is spatiotemporally continuous. Then, in step 50, the decoder 20 reconstructs TP from the PP field 18, generating reconstructed TP as output in step 52. Advantageously, the processing steps 40 allow for a smooth and continuous alternative for precipitation (for use in computer modeling) to be generated using machine learning. The model produces pseudo-precipitation based on an input pair of precipitation and VIMD for any specified coordinate, and allows for the accurate estimation of extreme precipitation. Pseudo-precipitation is more robust than precipitation when applied to downstream computer modeling tasks, such as downscaling, thereby significantly improving the speed and efficiency of computer-based climate modeling.

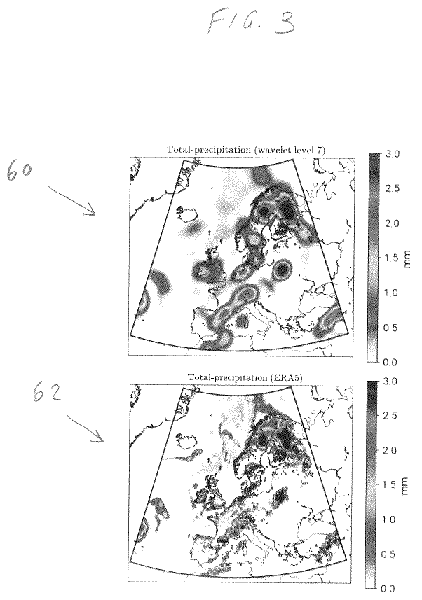

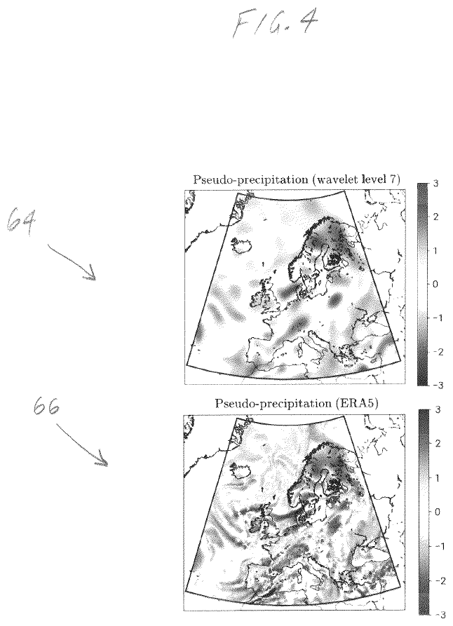

FIG. 3 illustrates low-and high-resolution pairs of total precipitation data, indicated respectively at 60 and 62. The TP data 60 and 62 (which can be generated using spherical wavelet transforms applied to TP data) leads to non-physical artifacts due to Gibbs phenomena. In contrast, the low-and high-resolution pairs of pseudo-precipitation (PP) data, shown in FIG. 4 and indicated, respectively, at 64 and 66, were generated using the techniques of the present disclosure and do not suffer from this phenomenon. Thus, the models generated by the systems and methods of the present disclosure significantly improve the modeling problems (e.g., Gibbs phenomenon) associated with TP modeling.

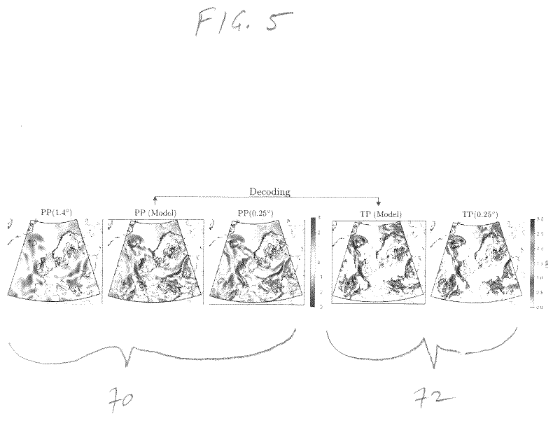

FIG. 5 illustrates decoding of downscaled pseudo-precipitation data (indicated at 70) downscaled by the systems and methods of the present disclosure to total precipitation data, indicated generally at 72. First, we generate paired low-resolution and high-resolution PP data from ERA5 reanalysis. The high-resolution data is at ERA5's native 0.25° (˜25 km) resolution. The low-resolution data is generated by spherical wavelet transforms of the high-resolution data, producing band-limited fields at a resolution of 1.4° (˜70 km), as shown in FIGS. 3-4. The downscaling framework integrates a spatio-temporal model, SimVP, with a diffusion model. Once the downscaling model is trained on PP, we decode TP at the target resolution using the decoder 20 of FIG. 1. Downscaled, decoded TP is used for investigating the overall performance of the present disclosure model. FIG. 5 provides a qualitative assessment of the predictions from our downscaling model, showing that the model successfully captures the fine-scale features (stochastic in nature), while preserving the large-scale structures.

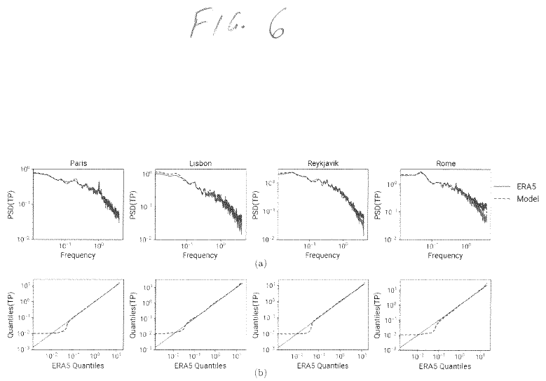

FIG. 6 depicts graphs illustrating power spectral density (PSD) and Q-Q plots. More specifically, the PSD is indicated in the upper graphs (labelled (a)) and the Q-Q plots are indicated in the lower graphs (labelled (b)). The PSD indicates the temporal power spectrum and the Q-Q plots display quantile plots for major European cities.

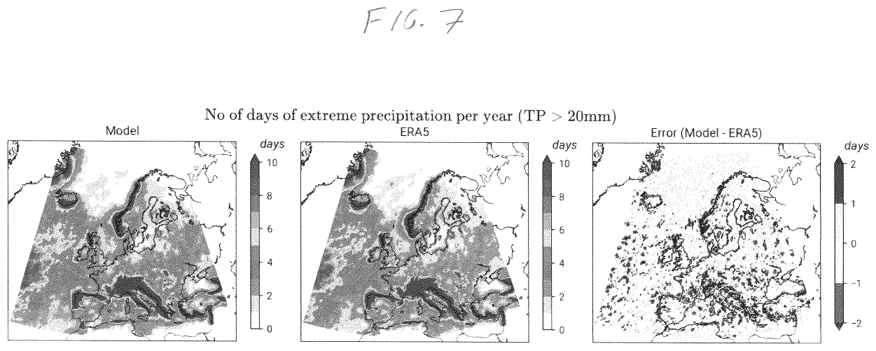

FIG. 7 illustrates comparison of the number of days of extreme precipitation per year for the model of the present disclosure versus the ERA5 dataset. As can be seen, the systems and methods of the present disclosure are in strong agreement with the ERA5 dataset.

The systems and methods of the present disclosure provide a machine learning based approach for generating pseudo-precipitation which is a spatio-temporally smooth and continuous field derived from TP and VIMD. The pseudo-precipitation field is a robust alternative to precipitation, particularly in downscaling applications. The systems and methods disclosed herein accurately estimate extreme precipitation and produces predictions that are consistent across the frequency spectrum when compared to ERA5. The pseudo-precipitation blending approach disclosed herein can also be applied to other statistical tasks, such as debiasing.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A machine learning system for precipitation modeling, comprising:
a precipitation modeling processor; and
a precipitation modeling engine executed by the processor, the precipitation modeling engine causing the processor to:
receive a first dataset including vertically-integrated moisture divergence (VIMD) data;
receive a second dataset including total precipitation (TP) data;
process the VIMD data and the TP data to blend the VIMD data and the TP data into a pseudo-precipitation (PP) field using a machine learning encoder; and
process the PP field using a machine learning decoder to reconstruct the TP data from the PP field.

2. The system of claim 1, wherein the machine learning encoder and the machine learning decoder comprise a fully-connected neural network.

3. The system of claim 1, wherein the precipitation modeling engine further causes the processor to align a distribution of the PP field with that of a standard normal distribution.

4. The system of claim 1, wherein the precipitation modeling engine decodes precipitation from a blended field generated by the machine learning encoder.

5. The system of claim 1, wherein the precipitation modeling engine generates the PP field by performing downscaling and wavelet filtering on input PP data.

6. The system of claim 1, wherein the PP field is a Gaussian field.

7. The system of claim 1, wherein the PP field does not suffer from non-physical artifacts due to Gibbs phenomenon.

8. A machine learning method for precipitation modeling, comprising:
receiving a first dataset including vertically-integrated moisture divergence (VIMD) data;
receiving a second dataset including total precipitation (TP) data;
processing the VIMD data and the TP data to blend the VIMD data and the TP data into a pseudo-precipitation (PP) field using a machine learning encoder; and
processing the PP field using a machine learning decoder to reconstruct the TP data from the PP field.

9. The method of claim 8, wherein the machine learning encoder and the machine learning decoder comprise a fully-connected neural network.

10. The method of claim 8, further comprising aligning a distribution of the PP field with that of a standard normal distribution.

11. The method of claim 8, further comprising decoding precipitation from a blended field generated by the machine learning encoder.

12. The method of claim 8, further comprising generating the PP field by performing downscaling and wavelet filtering on input PP data.

13. The method of claim 8, wherein the PP field is a Gaussian field.

14. The method of claim 8, wherein the PP field does not suffer from non-physical artifacts due to Gibbs phenomenon.
